(19) United States
(12) Patent Application Publication
(10) Pub. No.: US 2025/0185093 A1
(43) Pub. Date: Jun. 5, 2025

(54) SYSTEMS AND METHODS FOR MANAGING CONNECTIONS BETWEEN USER DEVICES AND WIRELESS NETWORKS

(71) Applicant: Comcast Cable Communications, LLC, Philadelphia, PA (US)

(72) Inventors: Raghavendra HEGDE, Wayne, PA (US); Saravanan MUTHUSAMY, Wayne, PA (US); Amarendar SIRIKONDA, Robbinsville, NJ (US); John B. HART, Philadephia, PA (US)

(21) Appl. No.: 18/528,016

(22) Filed: Dec. 4, 2023

(51) Int. Cl. H04W 76/15; H04W 48/16

(52) U.S. Cl. CPC H04W 76/15; H04W 48/16

(57) ABSTRACT

Methods and systems for establishing and managing connections between user devices and a network are disclosed. A user device may receive, from a wireless network, a message indicating that the user device can connect to the wireless network to download an embedded subscriber identity module (eSIM) associated with the wireless network. Based on receiving the message, a first connection may be caused to be established between the user device and the wireless network. Based on downloading the eSIM via the first connection, a second connection may be caused to be established between the user device and the wireless network. One or more services provided by the cellular network may be accessed via the second connection.

### BACKGROUND

User devices, such as mobile devices or cell phones, may comprise a subscriber identity module (SIM) card. The SIM card may store mobile subscription related information that a user device can use to connect to a particular network (e.g., wireless network, mobile network, cellular network). However, some users may face difficulties when trying to obtain a SIM card or to receive and install associated software. If a user cannot obtain a SIM card, the user may be unable to connect his or her user device to the network. Therefore, improvements in connection management techniques are desirable.

### SUMMARY

Methods and systems for managing connections between user devices and a wireless network are disclosed. A first connection may be established between a user device and a wireless network (e.g., a cellular network). The first connection may be a limited connection established to facilitate advertisement, announcement and download of an embedded subscriber identity module (eSIM) associated with the wireless network, e.g., by the user device. The user device may be able to download the eSIM via the first connection even if the user device has no connectivity to a local wireless network (e.g., WiFi based access point, non-cellular network). The first connection may be a limited connection in which the user device does not have access (e.g., is blocked from accessing) other data services typically provided to subscribers of the wireless network. For example, the user device may not be able to perform cellular calls and/or access application or data services. Rather, the first connection may only be able to access a particular service and/or server associated with downloading an eSIM. If the user device downloads the eSIM via the first connection, the user device may use the eSIM to establish a second connection with the wireless network. The user device may access one or more wireless services provided by the wireless network via the second connection, which may a more robust connection.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is an example system.

FIG. 2 is an example process.

FIG. 3 is an example

FIG. 4 is an example method.

FIG. 5 is an example method.

FIG. 6 is an example method.

FIG. 7 is an example computing device.

### DETAILED DESCRIPTION OF ILLUSTRATIVE EMBODIMENTS

Methods and systems for establishing connections between user devices and a network are disclosed. When a user subscribes to a wireless network provider (e.g., cellular communication network provider, wireless service provider), the user may receive mobile subscription related information from a service entity (e.g., carrier, mobile carrier) managing the wireless network. The mobile subscription related information may be in the form of a subscriber identity module (SIM) card. The SIM card may be a digital SIM card (e.g., an embedded subscriber identity module (eSIM)) downloaded to a user device and/or a physical SIM card inserted into the user device. The user device may utilize the mobile subscription related information indicated by the SIM card to connect to the wireless network. Once connected to the wireless network, the user device may access one or more services (e.g., voice communication service, a messaging communication service, and/or a mobile data service) provided by the wireless network.

However, the process of subscribing to a wireless network provider may be difficult, time-consuming, and/or inconvenient for many users. To subscribe to a wireless network provider, a user may be required to visit a retail store or an online portal associated with the wireless network provider. The user may provide payment details and identity proof and order a SIM card at the retail store or via the online portal. The user may then receive a physical SIM card at the retail store or through the mail. If the consumer requested an eSIM, a quick response (QR) code (e.g., or other uniform resource locator) associated with the eSIM may be emailed to the user. The user may utilize the QR code to download the eSIM to his or her user device. This subscription process may result in it taking anywhere from several hours to several days before the user device is able to access the service(s) provided by the wireless network provider.

If a retail store is not located proximate to the user and/or if the user cannot access the online portal (e.g., due to there being no Wi-fi connectivity), then it may be temporarily impossible for the user to subscribe to the wireless network provider. If the user cannot subscribe to the wireless network provider, the user will be unable to use his or her user device to access the service(s) provided by the wireless network. Accordingly, improved techniques for managing connections between user devices and wireless networks are desirable.

Described herein are improved techniques for managing connections between user devices and wireless networks. A wireless network provider may allow a user device to establish a first (e.g., limited, provisional) connection with the wireless network. The user device may utilize the first connection to subscribe to the wireless network provider and/or to download an eSIM associated with the wireless network. The first connection may be limited, in that the user device may be unable to access the voice communication service, the messaging communication service, and/or the mobile data service (e.g., except for limited access to download an eSIM) provided by the wireless network based on the first connection. The first connection may be established to facilitate the user device's download of the eSIM, even if the user device has no Wi-fi connectivity or other data services. The user device may utilize the downloaded eSIM to establish a second connection with the wireless network. The second connection may not have the same limitations as the first connection. Based on the established second connection, the user device may access one or more of the services (e.g., voice communication service, a messaging communication service, and/or a mobile data service) provided by the wireless network.

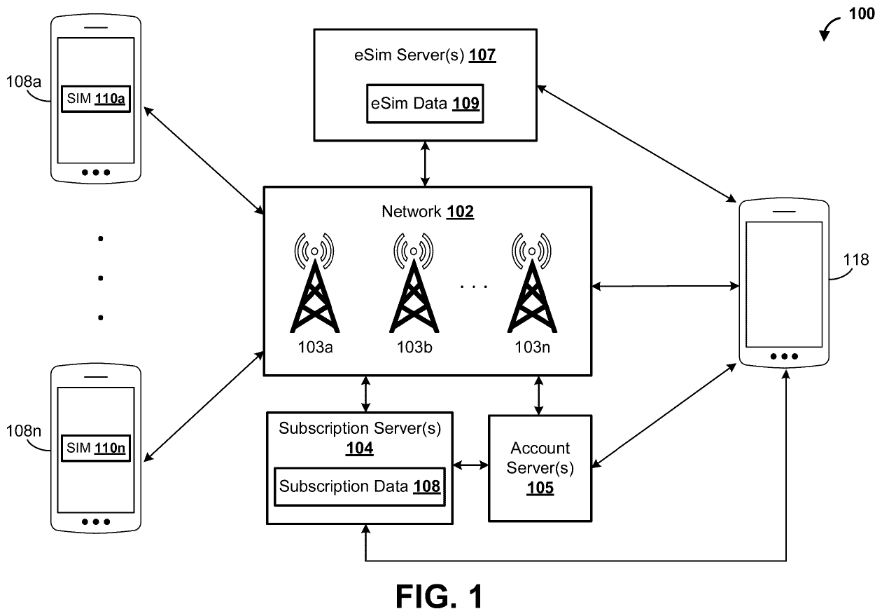

FIG. 1 shows a block diagram of an example system 100. The system 100 may comprise a network 102, a plurality of active subscriber user devices 108a-n, a user device 118, at least one eSIM server 107, at least one subscription server 104, and at least one account server 105.

The network 102 may comprise a network (e.g., wireless network, mobile network, cellular network) associated with a mobile network operator (MNO) (e.g., Verizon, Sprint, T-Mobile, AT&T, etc.) and/or one or more mobile virtual network operators (MVNOs) (e.g., versions of Xfinity Mobile, etc.). The network 102 may comprise a Radio Access Network (RAN) and a core network, which may be used to facilitate call services, such as outgoing calls, incoming calls, and/or the like. The network 102 may comprise an infrastructure configured to provide wireless services to customers (e.g., active subscribers). The infrastructure may comprise one or more base stations 103a-n. The base station(s) 103a-n may comprise a base transceiver station (BTS), a Node-B, an eNode-B, and/or any other network device configured to provide a wireless interface to the network 102. The base station(s) 103a-n may be part of a radio access network that may include other base stations and network elements (not shown). The base station(s) 103a-n may be configured to transmit and receive wireless signals on one or more carrier frequencies. The base station(s) 103a-n may also be referred to as cell(s) of the network 102. The base station(s) 103 may provide wireless services over a particular geographic area (e.g., coverage area).

The active member or subscriber user devices 108a-n may each be associated with an active subscription to the network 102. A user device may be an active member or subscriber user device if the user device already comprises a SIM card (e.g., physical SIM card and/or eSIM) for connecting to the network 102. A user associated with each of the active subscriber user devices 108a-n may have already signed up (e.g., paid for) for a wireless plan (e.g., subscription) provided by the network 102. The wireless plan may have been selected by the user from a plurality of wireless plan options. The selected wireless plan may indicate a set of services provided by the network 102 that are accessible to the user. The set of services may comprise one or more of a voice communication service, a messaging communication service, unlimited access to a mobile data service, and/or limited access to the mobile data service.

A particular SIM card from a plurality of SIM cards 110a-n may have been provisioned to each of the active subscriber user devices 108a-n based on the associated user signing up for a wireless plan. Each of the plurality of SIM cards 110a-n may comprise a physical SIM card or an eSIM. The active subscriber user device 108a may comprise the SIM card 110a. The SIM card 110a may comprise a physical SIM card that is inserted into the active subscriber user device 108a. The SIM card 110a may be a digital sim (e.g., eSIM) that has been downloaded to the active subscriber user device 108a. The active subscriber user device 108b may comprise both a physical SIM card and an eSIM. The active subscriber user device 108b may comprise the SIM card 110b. The SIM card 110b may comprise a physical SIM card that is inserted into the active subscriber user device 108b. The SIM card 110b may be a digital SIM card (e.g., eSIM) that has been downloaded to the active subscriber user device 108b. The active subscriber user device 108b may comprise both a physical SIM card and an eSIM. The active subscriber user device 108c may comprise the SIM card 110c, and so on. A physical SIM card may store one or more eSIM cards.

Each of the plurality of SIM cards 110a-n may be used by the corresponding active subscriber user device from the plurality of active subscriber user devices 108a-n to access the network 102. Each of the plurality of SIM cards 110a-n may store credentials (e.g., mobile subscription related information) for connecting to the network 102. The credentials for connecting to the network 102 may comprise one or more identifiers (e.g., user device identifiers, user identifiers, network identifiers, etc.). The identifiers may comprise an integrated circuit card identification number (ICCID). The identifiers may comprise an international mobile subscriber identity (IMSI). The IMSI may uniquely identify the plurality of active subscriber user devices 108a-n to the network 102 and/or identify the network 102 to the plurality of active subscriber user devices 108a-n. The identifiers may comprise cryptographic keys needed for authentication and access to the network 102 via the base station(s) 103a-n. The identifiers may comprise a group identifier (GID) that uniquely identifies a group of SIM cards for a particular application.

The active subscriber user device 108a may utilize the credentials stored on the SIM card 110a to connect to the network 102, the active subscriber user device 108b may utilize the credentials stored on the SIM card 110b to connect to the network 102, and so on. Based on connecting to the network 102, the plurality of active subscriber user device 108a-n may access one or more services provided by the network 102. Each of the plurality of active subscriber user device 108a-n may access the services indicated by the wireless plan corresponding to that particular SIM card from the plurality of SIM cards 110a-n.

The plurality of active subscriber user devices 108a-n and the base station(s) 103a-n may communicate over an air interface using any of a variety of suitable wireless communication technologies including, for example, radio frequency (RF), microwave, centimeter wave, infrared (IR), visible light, or the like. The plurality of active subscriber user devices 108a-n and the base station(s) 103a-n may implement any of a variety of cellular-based radio access technologies, such as, for example, Code Division Multiple Access (CDMA), High-Speed Packet Access (HSPA), Long Term Evolution (LTE), LTE-Advanced (LTE-A), LTE-Advanced Pro (LTE-A Pro), New Radio (e.g., 5G), or the like.

Each of the plurality of active subscriber user devices 108a-n may comprise any of a variety of different types of mobile devices (e.g., or stationary computing device), including for example, a smartphone, a tablet computer, a laptop computer, a notebook computer, a personal computer, a personal digital assistant (PDA), a user equipment (UE), a mobile station, a fixed or mobile subscriber unit, a pager, a wireless sensor, other consumer electronics, and the like. It should be noted that while the singular term device is used herein, it is contemplated that some devices may be implemented as a single device or a plurality of devices (e.g., via load balancing). Any device disclosed herein may be implemented using one or more computing nodes, such as virtual machines, executed on a single device and/or multiple devices.

The network 102 may allow user devices without an active subscription to the network 102, such as the user device 118, to connect to the network 102 to download an eSIM associated with the network 102. A network, such as the network 102, that allows user devices without an active subscription to connect to the network to download an eSIM may herein be referred to as “a network with on-demand subscription support.”

The user device 118 may not be associated with an active subscription to the network 102. The user device 118 may not comprise a SIM card associated with the network 102. The user device 118 may not comprise a SIM card associated with the network 102 if the user device 118 does not comprise a physical SIM card associated with the network 102 or an eSIM associated with the network 102. The user device 118 may comprise a physical SIM card associated with a different network (e.g., a network other than the network 102). If the user device 118 does not comprise a SIM card associated with the network 102, the user device 118 may be unable to access wireless services (e.g., voice communication service, a messaging communication service, and/or a mobile data service) provided by the network 102.

The network 102 (e.g., at least one of the base stations 103a-n) may be configured to broadcast (e.g., send) a message indicating that user devices can connect to the network 102 to download an eSIM associated with the network 102. The message may indicate that the network 102 is a network with on-demand subscription support. The network 102 and/or the base station(s) may be configured to broadcast the message continuously or periodically. The message may comprise a system information block (SIB) message. The message may comprise a dedicated field (e.g., capability flag) indicating that the network 102 supports on-demand subscriptions (e.g., that user devices can connect to the network 102 to download an eSIM associated with the network 102).

The user device 118 may receive the message from the network 102 and/or the at least one of the base station(s) 103a-n. The user device 118 may receive the message based on (e.g., in response to) the user device 118 scanning for networks with on-demand subscription support. The user device 118 may scan for networks with on-demand subscription support based on (e.g., in response to) being powered on. The user device 118 may scan for networks with on-demand subscription support based on (e.g., in response to) a user associated with the user device 118 attempting to sign up for a wireless network subscription. The user device 118 may additionally receive similar messages from other networks with on-demand subscription support based on the user device 118 scanning for networks with on-demand subscription support.

The user device 118 may be configured to cause display, such as on an interface of the user device 118, of a list of available networks with on-demand subscription support. The list of available networks may comprise a list of networks, including the network 102, from which the user device 118 received a message indicating on-demand subscription support. The user device 118 may be configured to display the network 102 in list of available networks with on-demand subscription support based on (e.g., in response to) receiving the message from the network 102.

The user device 118 may be a “carrier-locked” device. The user device 118 may be a carrier-locked device if the user device 118 supports on-demand subscription for the network 102, but not for other networks with on-demand subscription support. If the user device 118 is a carrier-locked device, the user device 118 may display only the network 102 in the list. If the user device 118 is a carrier-locked device, the user device 118 may display only the network 102 in the list even if the user device 118 receives messages from other networks indicating on-demand subscription support.

The user device 118 may be configured to receive an indication of a user selection. The user selection may comprise a selection of the network 102 from the displayed list of available networks with on-demand subscription support. A user associated with the user device 118 may select the network 102 from the displayed list of available networks with on-demand subscription support. The user may select the network 102 from the displayed list of available networks with on-demand subscription support if the user wants to gain access to one or more of the wireless services provided by the network 102. If the user device 118 receives an indication of a user selection of the network 102, the user device 118 may send a request to establish a first (e.g., limited, provisional) connection. The user device 118 may send the request to establish the first connection to the network 102 (e.g., to at least one of the base station(s) 103a-n).

The network 102 and/or the base station(s) 103a-n may receive the request to establish the first connection to the network 102. The network 102 and/or the base station(s) 103a-n may receive the request to establish the first connection to the network 102 from the user device 118. The network 102 and/or the base station(s) 103a-n may accept the request to establish the first connection to the network 102. Based on accepting the request to establish the first connection to the network 102, the network 102 and/or the base station(s) 103a-n may send an indication of the acceptance to the user device 118. The user device 118 may receive the indication of the acceptance from the network 102 and/or from the base station(s) 103a-n.

Based on (e.g., in response to) the user device 118 receiving the indication of the acceptance from the network 102 and/or from the base station(s) 103a-n, the first connection may be caused to be established between the network 102 and the user device 118. The user device 118 and/or the network 102 (e.g., one or more of the base station(s) 103a-n) may establish the first connection between the network 102 and the user device 118.

The first connection may be a limited connection, in that the user device 118 may be unable to access the wireless services, such as the voice communication service, the messaging communication service, and/or the mobile data service, provided by the network 102 based on the first connection. The first connection may be established for the limited purpose of facilitating download of the eSIM associated with the network 102 by the user device 118. To facilitate download of the eSIM associated with the network 102 by the user device 118, the network 102 may provide the user device 118 with access to one or more of the subscription server(s) 104, the account server(s) 105, and/or the eSIM server(s) 107. The network 102 may provide the user device 118 with access to one or more of the subscription server(s) 104, the account server(s) 105, and/or the eSIM server(s) 107 based on determining that the first connection between the user device 118 and the network 102 is established.

The user device 118 may be associated with a device identifier (ID). The device ID may comprise an ID that is unique to the user device 118. The device ID may comprise a serial number, such as an embedded universal integrated circuit card identifier (EID), corresponding to an eSIM installed in the user device 118. Based on (e.g., using) the first connection, the user device 118 may be configured to send the device ID to the subscription server(s) 104.

The subscription server(s) 104 may be configured to receive the device ID from the user device 118. The subscription server(s) 104 may utilize the device ID to determine if the user device 118 is associated with an inactive subscription to the network 102. The user device 118 may be associated with an inactive subscription to the network 102 if a user associated with the user device 118 has already signed-up for and/or paid for a wireless plan associated with the network 102 but has not downloaded the eSIM associated with that wireless plan on the user device 118. To determine if the user device 118 is associated with an inactive subscription to the network 102, the subscription server(s) 104 may determine whether the device ID corresponds to (e.g., is associated with) an existing eSIM associated with the wireless network 102.

If the subscription server(s) 104 determine that the device ID corresponds to (e.g., is associated with) an existing eSIM associated with the wireless network 102, this may indicate that the user device 118 is associated with an inactive subscription to the network 102. If the subscription server(s) 104 determine that the device ID corresponds to (e.g., is associated with) an existing eSIM associated with the wireless network 102, the subscription server(s) 104 may retrieve data or information associated with the inactive subscription. The data or information associated with the inactive subscription may indicate the wireless plan that the user has already signed-up for and/or paid for. The data or information associated with the inactive subscription may indicate a set of services provided by the network 102 that are accessible to the user based on the wireless plan. The set of services may comprise one or more of a voice communication service, a messaging communication service, unlimited access to a mobile data service, and/or limited access to the mobile data service.

The subscription server(s) 104 may be configured to send an indication of a location associated with the existing eSIM associated with the wireless network 102 to the user device 118. The subscription server(s) 104 may be configured to send an indication of the location associated with the existing eSIM to the user device 118 based on (e.g., using) the first connection. The subscription server(s) 104 may send the indication of the location associated with the existing eSIM to the user device 118 based on (e.g., in response to) retrieving the data or information associated with the inactive subscription. The location associated with the existing eSIM may comprise a location associated with the existing eSIM on the eSIM server(s) 107. The indication of the location may comprise a quick response (QR) code associated with the location of the existing eSIM on the eSIM server(s) 107.

The user device 118 may be configured to receive the indication of the location associated with the existing eSIM. The user device 118 may utilize the indication of the location associated with the existing eSIM to download the existing eSIM from the eSIM server(s) 107 to the user device 118. The user device 118 may download the existing eSIM from the eSIM server(s) 107 based on (e.g., using) the first connection. The user device 118 may activate the downloaded eSIM. The user device 118 may register the downloaded and/or activated eSIM with the network 102. The user device 118 may register the downloaded and/or activated eSIM with the network 102 based on (e.g., in response to) downloading and/or activating the eSIM.

Conversely, if the subscription server(s) 104 determine that the device ID does not correspond to an existing eSIM associated with the wireless network 102, this may indicate that the user device 118 is not associated with a subscription (e.g., inactive or active) to the network 102. If the subscription server(s) 104 determine that the device ID does not correspond to an existing eSIM associated with the wireless network 102, the subscription server(s) 104 may send an indication of a location associated with the account server(s) 105 to the user device 118.

The user device 118 may be configured to receive the indication of a location associated with the account server(s) 105. The user device 118 may utilize the indication of a location associated with the account server(s) 105 to subscribe to the network 102 (e.g., to sign-up for a wireless plan with the network 102). Based on the user device 118 receiving the indication of a location associated with the account server(s) 105, a subscription connection may be established between the user device 118 and the account server(s) 105. Based on establishment of the subscription connection, the account server(s) 105 may cause initiation of a subscription process.

The account server(s) 105 may initiate the subscription process by causing the user device 118 to display information, such as on an interface of the user device 118, instructing a user associated with the user device 118 to select a wireless plan, provide identification, and/or pay for the selected wireless plan. The user may select a desired wireless plan, provide identification, and/or pay for the selected wireless plan via the user device 118. If the user selects a desired wireless plan, provides identification, and/or pays for the selected wireless plan via the user device 118, the subscription process may be complete.

Based on completion of the subscription process, the subscription server(s) 104 may send an indication (e.g., an instruction) to provision a new eSIM to the eSIM server(s) 107. The new eSIM may comprise an eSIM that corresponds to the wireless plan selected by the user of the user device 118 during the subscription process. The eSIM server(s) 107 may receive the indication to provision the new eSIM. Based on receiving the indication to provision the new eSIM, the eSIM server(s) 107 may create (e.g., generate, provision) the new eSIM.

The subscription server(s) 104 may be configured to send an indication of a location associated with the new eSIM to the user device 118. The subscription server(s) 104 may send the indication of the location associated with the new eSIM to the user device 118 based on (e.g., in response to) determining that the new eSIM has been created. The location associated with the new eSIM may comprise a location associated with the new eSIM on the eSIM server(s) 107. The indication of the location may comprise a quick response (QR) code associated with the location of the new eSIM on the eSIM server(s) 107.

The user device 118 may be configured to receive the indication of the location associated with the new eSIM. The user device 118 may utilize the indication of the location associated with the new eSIM to download the new eSIM from the eSIM server(s) 107 to the user device 118. The user device 118 may activate the downloaded eSIM. The user device 118 may register the downloaded and/or activated eSIM with the network 102. The user device 118 may register the downloaded and/or activated eSIM with the network 102 based on (e.g., in response to) downloading and/or activating the eSIM.

The user device 118 may be configured to utilize the registered eSIM to cause a second (e.g., unlimited) connection to be established between the user device 118 and the network 102. The registered eSIM may store credentials (e.g., mobile subscription related information) for connecting to the network 102. The credentials for connecting to the network 102 may comprise one or more of an integrated circuit card identification number (ICCID), an international mobile subscriber identity (IMSI), cryptographic keys needed for authentication and access to the network 102 via the base station(s) 103a-n, or a group identifier (GID) that uniquely identifies a group of SIM cards for a particular application. The user device 118 may utilize the credentials stored on the registered SIM card to establish the second connection to the network 102.

Based on the second connection, the user device 118 may access one or more services provided by the network 102. The one or more services may comprise at least one service indicated by the wireless plan associated with the registered eSIM. The at least one service may comprise one or more of the voice communication service, the messaging communication service, and/or the mobile data service provided by the network 102. Based on accessing the voice communication service, the user device 118 may be able to make and receive telephone calls to and from other user devices. Based on accessing the messaging communication service, the user device 118 may be able to exchange text (e.g., SMS) messages with other user devices. Based on accessing the mobile data service, the user device 118 may be able to access the internet.

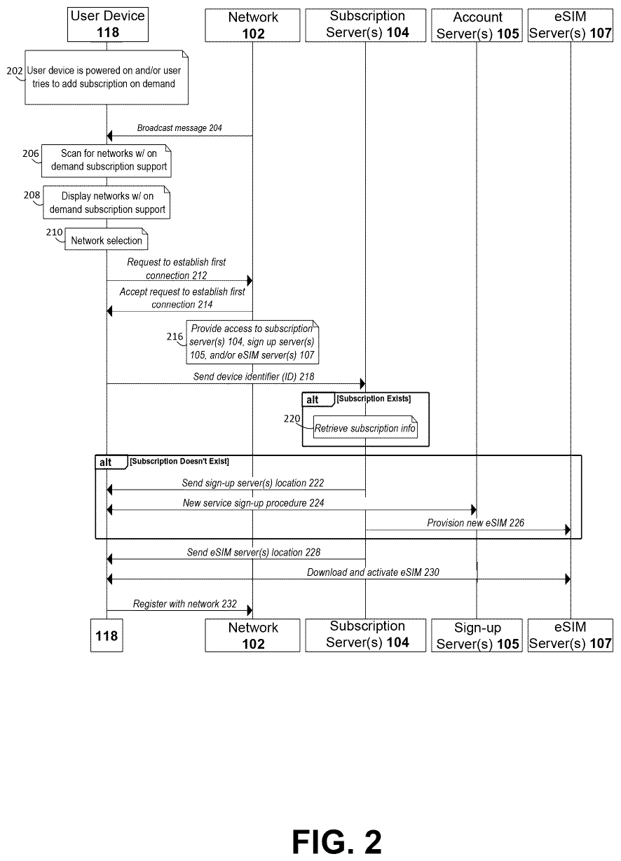

FIG. 2 is a process 200 for managing connections between user devices and a wireless network. At 202, the user device 118 is powered on and/or a user associated with the user device 118 attempts to add a subscription on demand (e.g., download an eSIM). Adding a subscription on demand may comprise a process that a user may initiate via a user device to start a subscription for a communication service (e.g., cellular service, network service, calling service). The process may include downloading an eSIM allowing the user to start using the communication service without having to go into a physical branch of the service provider. At 204, the network 102 (e.g., at least one of the base stations 103a-n) may be configured to broadcast a message indicating that user devices can connect to the network 102 to download an eSIM associated with the network 102. The message may indicate that the network 102 is a network with on-demand subscription support. The network 102 and/or the base station(s) may be configured to broadcast the message continuously or periodically. The message may comprise a system information block (SIB) message. The message may comprise a dedicated field (e.g., capability flag) indicating that the network 102 supports on-demand subscriptions (e.g., that user devices can connect to the network 102 to download an eSIM associated with the network 102).

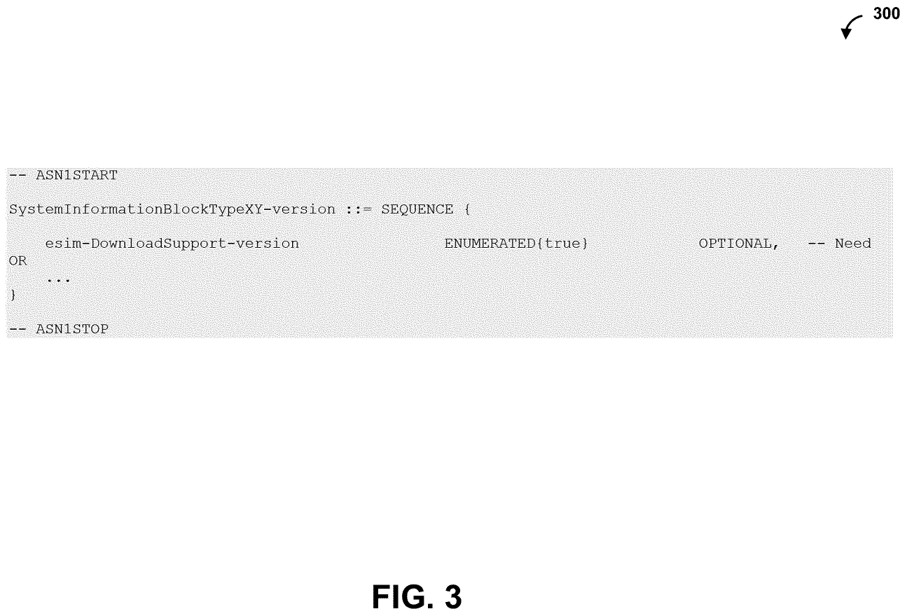

FIG. 3 is an example message 300. The message 300 may comprise a system information block (SIB) message. The SIB message may comprise a new SIB message, such as a new SIB message for the 3rd Generation Partnership Project (3GPP) TS 36.331 specification. The message 300 may indicate that the network that sent (e.g., broadcasted) the message supports on-demand subscription. The message 300 may be associated with (e.g., defined based on) a unique value, type (e.g., type XY), and/or length.

The unique value may be a unique number or set of numbers associated with a particular version or release of a communication protocol, such as a 3GPP protocol. The unique value may comprise a field, variable name, parameter name, and/or the like associated with support for eSIM download. For example, the unique value may indicate that the message 300 is associated with eSIM download. The message 300 may comprise a field indicating an eSIM download capability, such as a field entitled “esim-DownloadSupport-version.” The field may have a value indicating support for the capability. For example, FIG. 3 shows a definition indicating the value may have an enumerated type and may have a true value to indicate that the network that sent (e.g., broadcasted) the message supports the capability, but other types such as Boolean or integers may be used instead. If the value of the field is enumerated as “true,” as shown in the example of FIG. 3, this may indicate that the network that sent (e.g., broadcasted) the message supports on-demand eSIM subscriptions. If the value of the field is enumerated as “false,” this may indicate that the network that sent (e.g., broadcasted) the message does not support on-demand subscriptions.

The message 300 may be encoded for transmission over the air by the network. The message 300 may be encoded using ASN.1 and/or any other suitable encoding format. The encoded message may have a specified length. The length may be fixed for a particular encoding format (e.g., BER, PER aligned/unaligned, etc.). The length may allow for specific bit or byte values to be analyzed to determine the message and/or information within the message.

Referring back to FIG. 2, at 206, the user device 118 may perform a scan for networks with on-demand subscription support. The user device 118 may scan for broadcasted messages comprising the capability flag. The user device 118 may receive the message from the network 102 and/or the at least one of the base station(s) 103a-n. The user device 118 may receive the message based on (e.g., in response to) the user device 118 scanning for networks with on-demand subscription support. The user device 118 may additionally receive similar messages from other networks with on-demand subscription support based on the user device 118 scanning for networks with on-demand subscription support.

At 208, the user device 118 may cause display, such as on an interface of the user device 118, of a list of available networks with on-demand subscription support. The list of available networks may comprise a list of networks, including the network 102, from which the user device 118 received a message indicating on-demand subscription support. At 210, the user device 118 may receive an indication of a user selection. The user selection may comprise a selection of the network 102 from the displayed list of available networks with on-demand subscription support. A user associated with the user device 118 may select the network 102 from the displayed list of available networks with on-demand subscription support. The user may select the network 102 from the displayed list of available networks with on-demand subscription support if the user wants to gain access to one or more of the wireless services provided by the network 102.

At 212, the user device 118 may request to establish a first (e.g., limited, provisional) connection to the network 102. The user device 118 may request to establish the first connection to the network 102 based on the user device 118 receiving the indication of the user selection of the network 102. The user device 118 may request to establish the first connection to the network 102 by sending a request to establish the first connection to the network 102 (e.g., to at least one of the base station(s) 103a-n). The network 102 and/or the base station(s) 103a-n may receive the request to establish the first connection from the user device 118.

At 214, the network 102 and/or the base station(s) 103a-n may accept the request to establish the first connection to the network 102. Based on accepting the request to establish the first connection to the network 102, the network 102 and/or the base station(s) 103a-n may send an indication of the acceptance to the user device 118. The user device 118 may receive the indication of the acceptance from the network 102 and/or from the base station(s) 103a-n.

Based on (e.g., in response to) the user device 118 receiving the indication of the acceptance from the network 102 and/or from the base station(s) 103a-n, the first connection may be caused to be established between the network 102 and the user device 118. The user device 118 and/or the network 102 (e.g., one or more of the base station(s) 103a-n) may establish the first connection between the network 102 and the user device 118. The first connection may be a limited connection, in that the user device 118 may be unable to access the wireless services, such as the voice communication service, the messaging communication service, and/or the mobile data service, provided by the network 102 based on the first connection.

The first connection may be established for the limited purpose of facilitating download of the eSIM associated with the network 102 by the user device 118. To facilitate download of the eSIM associated with the network 102 by the user device 118, the network 102 may provide the user device 118 with access to one or more of the subscription server(s) 104, the account server(s) 105, and/or the eSIM server(s) 107. At 216, the network 102 may provide the user device 118 with access to one or more of the subscription server(s) 104, the account server(s) 105, and/or the eSIM server(s) 107 based on determining that the first connection between the user device 118 and the network 102 is established.

The user device 118 may be associated with a device ID. The device ID may comprise an ID that is unique to the user device 118. The device ID may comprise a serial number, such as an embedded universal integrated circuit card (eUICC) identifier (EID), corresponding to an eSIM installed in the user device 118. At 218, the user device 118 may send the device ID to the subscription server(s) 104. The user device may be configured to send the device ID to the subscription server(s) 104 using the first connection.

The subscription server(s) 104 may receive the device ID from the user device 118. The subscription server(s) 104 may utilize the device ID to determine if the user device 118 is associated with an inactive subscription to the network 102. The user device 118 may be associated with an inactive subscription to the network 102 if a user associated with the user device 118 has already signed-up for and/or paid for a wireless plan associated with the network 102 but has not downloaded, activated, or registered the eSIM associated with that wireless plan. To determine if the user device 118 is associated with an inactive subscription to the network 102, the subscription server(s) 104 may determine whether the device ID corresponds to (e.g., is associated with) an existing eSIM associated with the wireless network 102.

If the subscription server(s) 104 determine that the device ID corresponds to (e.g., is associated with) an existing eSIM associated with the wireless network 102, this may indicate that the user device 118 is associated with an inactive subscription to the network 102. If the subscription server(s) 104 determine that the device ID corresponds to (e.g., is associated with) an existing SIM associated with the wireless network 102, the process 200 may proceed to operation 220. At 220, the subscription server(s) 104 may retrieve data or information associated with the inactive subscription. The data or information associated with the inactive subscription may indicate the wireless plan that the user has already signed-up for and/or paid for. The data or information associated with the inactive subscription may indicate a set of services provided by the network 102 that are accessible to the user based on the wireless plan. The set of services may comprise one or more of a voice communication service, a messaging communication service, unlimited access to a mobile data service, and/or limited access to the mobile data service. The process may proceed to operation 228.

If the subscription server(s) 104 determine that the device ID does not correspond to an existing eSIM associated with the wireless network 102, this may indicate that the user device 118 is not associated with a subscription (e.g., inactive or active) to the network 102. If the subscription server(s) 104 determine that the device ID does not correspond to an existing eSIM associated with the wireless network 102, the process 200 may proceed to operation 222.

At 222, the subscription server(s) 104 may send an indication of a location associated with the account server(s) 105 to the user device 118. The user device 118 may receive the indication of a location associated with the account server(s) 105. The user device 118 may utilize the indication of a location associated with the account server(s) 105 to subscribe to the network 102 (e.g., to sign-up for a wireless plan with the network 102). Based on the user device 118 receiving the indication of a location associated with the account server(s) 105, a subscription connection may be established between the user device 118 and the account server(s) 105.

Based on establishment of the subscription connection, the account server(s) 105 may cause initiation of a subscription (e.g., new service sign-up) process. At 224, the new service sign-up process may be initiated. The account server(s) 105 may initiate the new service sign-up process by causing the user device 118 to display information, such as on an interface of the user device 118, instructing (e.g., prompting) a user associated with the user device 118 to select a wireless plan, provide identification, and/or pay for the selected wireless plan. The user may select a desired wireless plan, provide identification, and/or pay for the selected wireless plan via the user device 118. If the user selects a desired wireless plan, provides identification, and/or pays for the selected wireless plan via the user device 118, the new service sign-up process may be complete.

At 226, the subscription server(s) 104 may send an indication (e.g., an instruction) to provision a new eSIM to the eSIM server(s) 107. The new eSIM may comprise an eSIM that corresponds to the wireless plan selected by the user of the user device 118 during the new service sign-up process. The eSIM server(s) 107 may receive the indication to provision the new eSIM. Based on receiving the indication to provision the new eSIM, the eSIM server(s) 107 may create (e.g., generate, provision) the new eSIM.

At 228, the subscription server(s) 104 may be configured to send an indication of a location associated with the eSIM (e.g., the existing eSIM or the new eSIM) associated with the wireless network 102 to the user device 118. The subscription server(s) 104 may be configured to send an indication of the location associated with the eSIM to the user device 118 based on (e.g., using) the first connection. The location associated with the eSIM may comprise a location associated with the eSIM on the eSIM server(s) 107. The indication of the location may comprise a quick response (QR) code associated with the location of the eSIM on the eSIM server(s) 107.

The user device 118 may be configured to receive the indication of the location associated with the eSIM. At 230, the user device 118 may download and/or activate the eSIM. The user device 118 may download and/or activate the eSIM based on the indication of the location associated with the eSIM. The user device 118 may download the existing eSIM from the eSIM server(s) 107 based on (e.g., using) the first connection. The user device 118 may activate the downloaded eSIM. At 232, the user device 118 may register the downloaded and/or activated eSIM with the network 102. The user device 118 may register the downloaded and/or activated eSIM with the network 102 based on (e.g., in response to) downloading and/or activating the eSIM.

The user device 118 may be configured to utilize the registered eSIM to cause a second (e.g., unlimited) connection to be established between the user device 118 and the network 102. The registered eSIM may store credentials (e.g., mobile subscription related information) for connecting to the network 102. The user device 118 may utilize the credentials stored on the registered SIM card to establish the second connection to the network 102. Based on the second connection, the user device 118 may access one or more services provided by the network 102. The one or more services may comprise at least one service indicated by the wireless plan associated with the registered eSIM. The at least one service may comprise one or more of the voice communication service, the messaging communication service, and/or the mobile data service provided by the network 102.

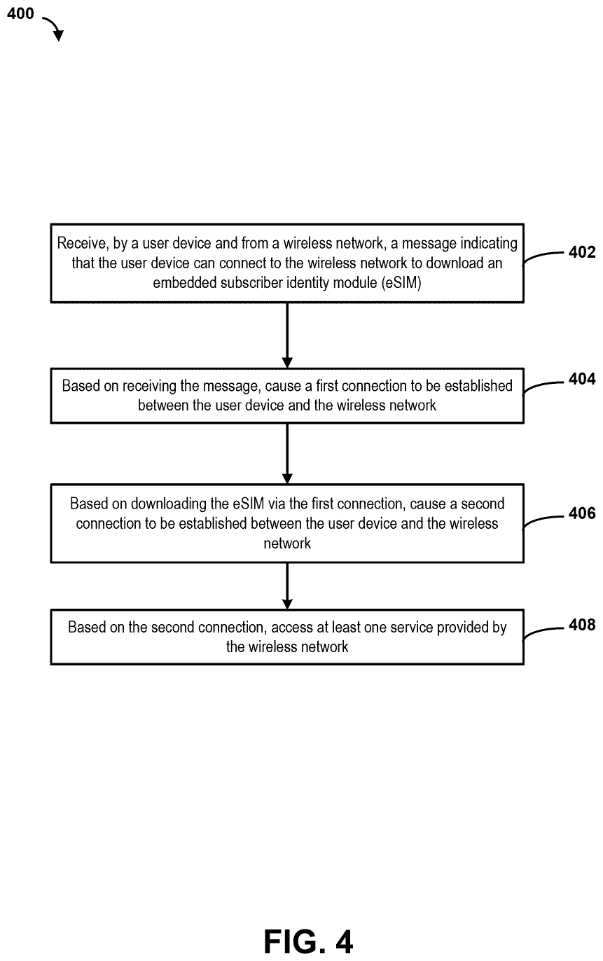

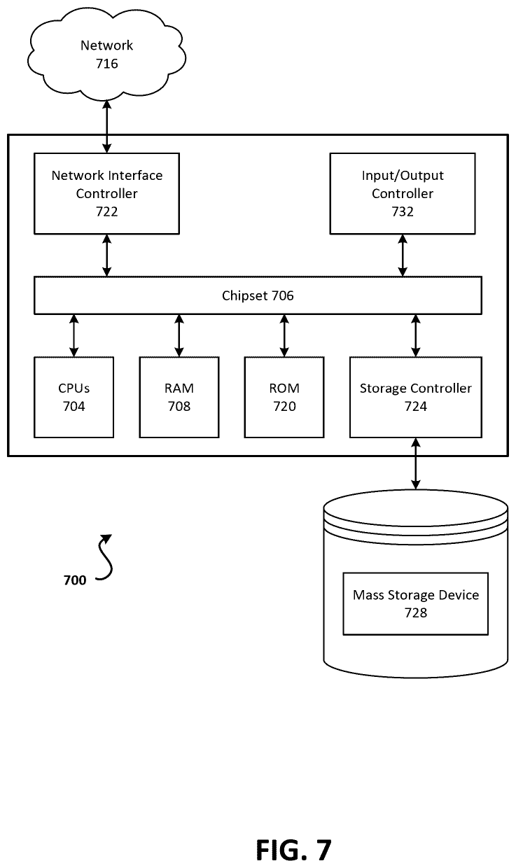

FIG. 4 is an example method 400. The method 400 may comprise a computer implemented method for managing connections between user devices and a network. A system and/or computing environment, such as the system 100 of FIG. 1 and/or the computing environment of FIG. 7, may be configured to perform the method 400. For example, the user device 118 of FIG. 1 and FIG. 2 may be configured to perform the method 400.

A user device may scan for networks with on-demand subscription support. The user device may scan for networks with on-demand subscription support based on (e.g., in response to) being powered on. The user device may scan for networks with on-demand subscription support based on (e.g., in response to) a user associated with the user device attempting to sign up for a wireless network subscription.

At 402, a message may be received. The message may be received by the user device. The message may be received from a wireless network (e.g., from at least one base station associated with the wireless network). The message may indicate that the user device can connect to the wireless network to download an embedded subscriber identity module (eSIM). The message may indicate that the wireless network is a network with on-demand subscription support. The message may comprise a system information block (SIB) message. The message may comprise a dedicated field (e.g., capability flag) indicating that the wireless network supports on-demand subscriptions. The user device may receive the message from the wireless network based on (e.g., in response to) the user device scanning for networks with on-demand subscription support. The user device may additionally receive similar messages from other networks with on-demand subscription support based on the user device scanning for networks with on-demand subscription support.

At 404, a first connection may be caused to be established. The first connection may be caused to be established between the user device and the wireless network. The first connection may be caused to be established based on receiving the message.

To cause the first connection to be established, the user device may cause display, such as on an interface of the user device, of a list of available networks with on-demand subscription support. The list of available networks may comprise a list of networks from which the user device received a message indicating on-demand subscription support. The user device may receive an indication of a user selection. The user selection may comprise a selection of the wireless network from the displayed list of available networks with on-demand subscription support. A user associated with the user device may select the wireless network from the displayed list of available networks with on-demand subscription support. The user may select the wireless network from the displayed list of available networks with on-demand subscription support if the user wants to gain access to one or more of the wireless services provided by the wireless network. If the user device receives an indication of a user selection of the wireless network, the user device may send a request to establish a first (e.g., limited, provisional) connection to the wireless network.

The wireless network may receive the request to establish the first connection to the wireless network. The wireless network may receive the request to establish the first connection to the wireless network from the user device. The wireless network may accept the request to establish the first connection to the wireless network. Based on accepting the request to establish the first connection to the wireless network, the wireless network may send an indication of the acceptance to the user device. The user device may receive the indication of the acceptance from the wireless network. Based on (e.g., in response to) the user device receiving the indication of the acceptance from the wireless network, the first connection may be caused to be established between the wireless network and the user device. The user device and/or the wireless network may establish the first connection between the wireless network and the user device.

The first connection may be a limited connection, in that the user device may be unable to access the wireless services, such as the voice communication service, the messaging communication service, and/or the mobile data service, provided by the wireless network based on the first connection. The first connection may be established for the limited purpose of facilitating download of the eSIM associated with the wireless network by the user device.

Based on the first connection, the user device may receive an indication of a location associated with the eSIM associated with the wireless network. The location associated with the eSIM may comprise a location associated with the eSIM on one or more servers associated with the wireless network. The user device may download and/or activate the eSIM. The user device may download and/or activate the eSIM based on the indication of the location associated with the eSIM. The user device may download the eSIM based on (e.g., using) the first connection. The user device may activate the downloaded eSIM. The user device may register the downloaded and/or activated eSIM with the wireless network.

At 406, a second connection may be caused to be established. The second connection may be caused to be established between the user device and the wireless network. The second connection may be caused to be established based on downloading the eSIM via the first connection. The eSIM may store credentials (e.g., mobile subscription related information) for connecting to the network. The user device may utilize the credentials stored on the SIM card to establish the second connection to the network.

At 408, at least one service provided by the wireless network may be accessed. The at least one service may be accessed based on the second connection. The one or more services may comprise at least one service indicated by the wireless plan associated with the eSIM. The at least one service may comprise one or more of the voice communication service, the messaging communication service, and/or the mobile data service provided by the network.

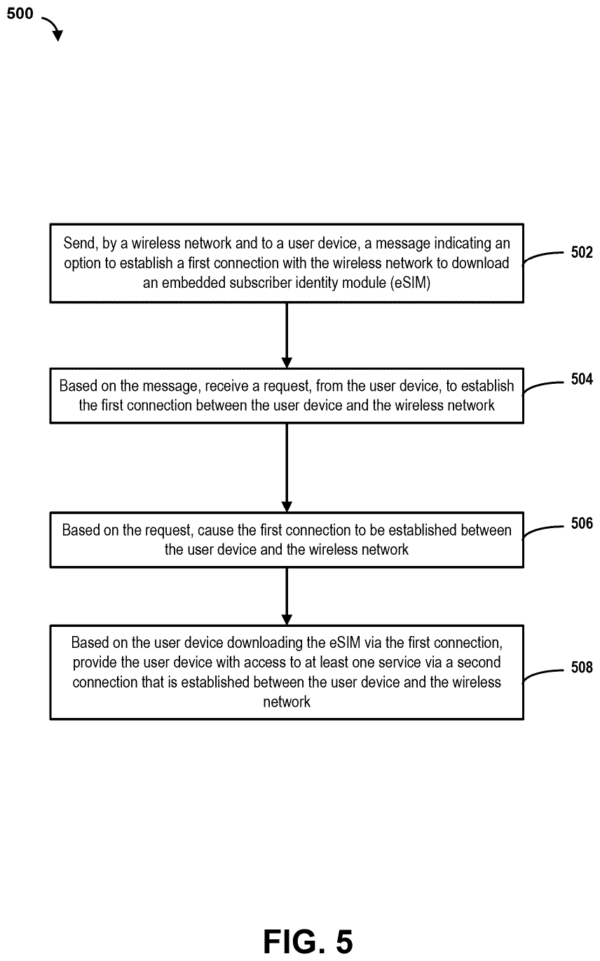

FIG. 5 is an example method 500. The method 500 may comprise a computer implemented method for managing connections between user devices and a network. A system and/or computing environment, such as the system 100 of FIG. 1 and/or the computing environment of FIG. 7, may be configured to perform the method 500. For example, the network 102 may be configured to perform the method 500.

At 502, a message may be sent. The message may be sent by a wireless network. The message may be sent to a user device. The message may indicate an option to connect to the wireless network to download an eSIM. The network (e.g., at least one of the base stations associated with the network) may be configured to broadcast (e.g., send) the message continuously or periodically. The message may comprise a system information block (SIB) message. The message may comprise a dedicated field (e.g., capability flag) indicating that the network supports on-demand subscriptions (e.g., that user devices have the option to connect to the network to download an eSIM associated with the network).

The message may be received by a user device. The user device may send a request to establish a first (e.g., limited, provisional) connection to the wireless network based on receiving the message. At 504, the request to establish the first connection may be received. The request to establish the first connection may be received from the user device. The request to establish the first connection may be received based on the user device receiving the message.

At 506, the first connection may be caused to be established. The first connection may be caused to be established based on acceptance of the request. The first connection may be established between the user device and the wireless network. Causing the first connection to be established may comprise sending an indication of acceptance of the request to the user device. The user device may receive the indication of the acceptance. Based on (e.g., in response to) the user device receiving the indication of the acceptance from the wireless network, the first connection may be caused to be established between the wireless network and the user device. The user device and/or the wireless network may establish the first connection between the wireless network and the user device.

The first connection may be a limited connection, in that the user device may be unable to access the wireless services, such as the voice communication service, the messaging communication service, and/or the mobile data service, provided by the wireless network based on the first connection. The first connection may be established for the limited purpose of facilitating download of the eSIM associated with the wireless network by the user device. Based on the first connection, the user device may download the eSIM. The user device may download the eSIM from at least one server associated with the wireless network. The user device may activate the downloaded eSIM. The user device may register the downloaded and/or activated eSIM with the wireless network.

A second connection may be caused to be established. The second connection may be caused to be established between the user device and the wireless network. The second connection may be caused to be established based on the user device downloading the eSIM via the first connection. The eSIM may store credentials (e.g., mobile subscription related information) for connecting to the network. The user device may utilize the credentials stored on the SIM card to establish the second connection to the network. At 508, the user device may be provided with access to at least one service via the second connection. The at least one service may comprise at least one service indicated by the wireless plan associated with the eSIM. The at least one service may comprise one or more of the voice communication service, the messaging communication service, and/or the mobile data service provided by the network.

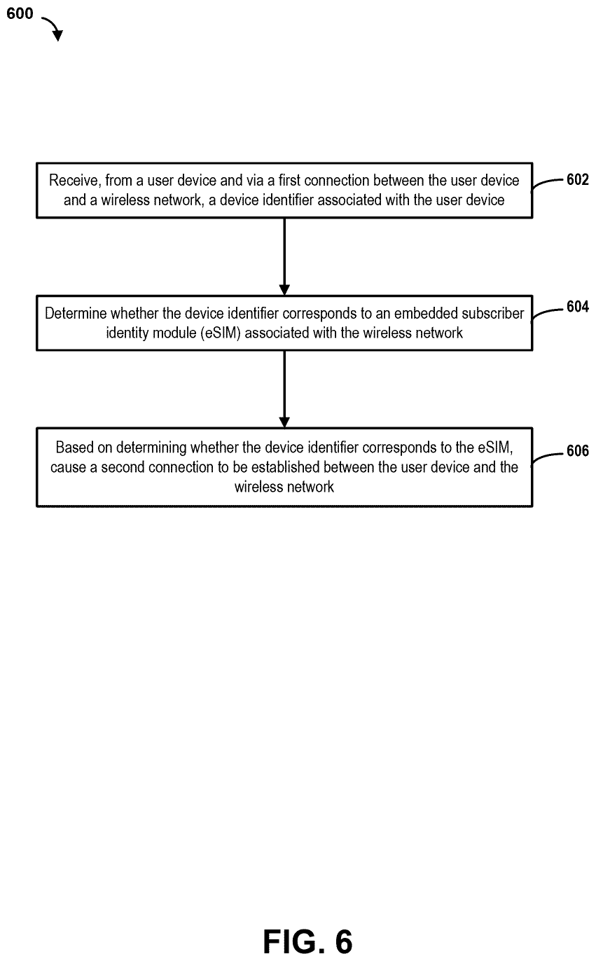

FIG. 6 is an example method 600. The method 600 may comprise a computer implemented method for managing connections between user devices and a network. A system and/or computing environment, such as the system 100 of FIG. 1 and/or the computing environment of FIG. 7, may be configured to perform the method 600. For example, the subscription server(s) 104 may be configured to perform the method 600.

A user device may be associated with a device identifier (ID). The device ID may comprise an ID that is unique to the user device. The device ID may comprise a serial number, such as an embedded universal integrated circuit card identifier (EID), corresponding to an eSIM installed in the user device. At 602, the device ID associated with the user device may be received. The device ID may be received based on a first (e.g., limited, provisional) connection established between the user device and a wireless network. The device ID may be received via at least one server (e.g., subscription server) associated with the wireless network. The device ID may be received from the user device.

At 604, it may be determined whether the device ID corresponds to an existing eSIM associated with the wireless network. If the device ID corresponds to an existing eSIM associated with the wireless network, this may indicate that the user device is associated with an inactive subscription to the wireless network. The user device may be associated with an inactive subscription to the wireless network if a user associated with the user device has already signed-up for and/or paid for a wireless plan associated with the wireless network but has not downloaded, activated, and/or registered the eSIM associated with that wireless plan on the user device.

At 606, a second connection may be caused to be established. The second connection may be caused to be established between the user device and the wireless network. The second connection may be caused to be established based on determining whether the device ID corresponds to an existing eSIM.

If the device ID corresponds to (e.g., is associated with) an existing eSIM associated with the wireless network, data or information associated with the inactive subscription may be retrieved. The data or information associated with the inactive subscription may indicate the wireless plan that the user has already signed-up for and/or paid for. The data or information associated with the inactive subscription may indicate a set of services provided by the wireless network that are accessible to the user device based on the wireless plan. The set of services may comprise one or more of a voice communication service, a messaging communication service, unlimited access to a mobile data service, and/or limited access to the mobile data service.

An indication of a location associated with the existing eSIM may be sent to the user device. The indication of the location associated with the existing eSIM may be sent to the user device based on (e.g., using) the first connection. The location associated with the existing eSIM may comprise a location associated with the existing eSIM on one or more servers associated with the wireless network. The user device may receive the indication of the location associated with the existing eSIM. The user device may utilize the indication of the location associated with the existing eSIM to download the existing eSIM from the server(s) to the user device. The user device may download the existing eSIM based on (e.g., using) the first connection. The user device may activate the downloaded eSIM. The user device may register the downloaded and/or activated eSIM with the wireless network.

Conversely, if the device ID does not correspond to an existing eSIM associated with the wireless network, an indication of a location associated with the one or more account servers may be sent to the user device. The user device may receive the indication of a location associated with the account server(s). The user device may utilize the indication of a location associated with the account server(s) to subscribe to the wireless network (e.g., to sign-up for a wireless plan with the network). Based on the user device receiving the indication of a location associated with the account server(s), the user device 118 may cause display of information, such as on an interface of the user device. The information may instruct a user associated with the user device to select a wireless plan, provide identification, and/or pay for the selected wireless plan. The user may select a desired wireless plan, provide identification, and/or pay for the selected wireless plan via the user device. If the user selects a desired wireless plan, provides identification, and/or pays for the selected wireless plan via the user device, the subscription process may be complete.

Based on completion of the subscription process, an indication (e.g., an instruction) to provision a new eSIM may be sent to one or more eSIM servers. The new eSIM may comprise an eSIM that corresponds to the wireless plan selected by the user of the user device during the subscription process. The eSIM server(s) may receive the indication to provision the new eSIM. Based on receiving the indication to provision the new eSIM, the eSIM server(s) may create (e.g., generate, provision) the new eSIM.

An indication of a location associated with the new eSIM may be sent to the user device. The indication of the location associated with the new eSIM may be sent to the user device based on (e.g., in response to) determining that the new eSIM has been created. The location associated with the new eSIM may comprise a location associated with the new eSIM on the eSIM server(s). The user device may receive the indication of the location associated with the new eSIM. The user device may utilize the indication of the location associated with the new eSIM to download the new eSIM from the eSIM server(s) to the user device. The user device may activate the downloaded eSIM. The user device may register the downloaded and/or activated eSIM with the wireless network.

The registered eSIM may store credentials (e.g., mobile subscription related information) for connecting to the wireless network. The credentials for connecting to the wireless network may comprise one or more of an integrated circuit card identification number (ICCID), an international mobile subscriber identity (IMSI), cryptographic keys needed for authentication and access to the wireless network, or a group identifier (GID) that uniquely identifies a group of SIM cards for a particular application. The user device may utilize the credentials stored on the registered SIM card to establish the second connection to the network.

Based on the second connection, the user device may access one or more services provided by the wireless network. The one or more services may comprise at least one service indicated by the wireless plan associated with the registered eSIM. The at least one service may comprise one or more of the voice communication service, the messaging communication service, and/or the mobile data service provided by the network wireless network.

FIG. 7 depicts a computing device that may be used in various aspects, such as the servers and/or devices depicted in FIG. 1. With regard to the example architecture of FIG. 1, the network 102, the plurality of active subscriber user devices 108a-n, the user device 118, the at least one eSIM server 107, the at least one subscription server 104, and the at least one account server 105 may each be implemented in an instance of a computing device 700 of FIG. 7.

The computer architecture shown in FIG. 7 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIG. 4, FIG. 5, FIG. 6 and elsewhere herein.

The computing device 700 may include a baseboard, or “motherboard,” which is a printed circuit board to which a multitude of components or devices may be connected by way of a system bus or other electrical communication paths. One or more central processing units (CPUs) 704 may operate in conjunction with a chipset 706. The CPU(s) 704 may be standard programmable processors that perform arithmetic and logical operations necessary for the operation of the computing device 700.

The CPU(s) 704 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 704 may be augmented with or replaced by other processing units, such as GPU(s). The GPU(s) may comprise processing units specialized for but not necessarily limited to highly parallel computations, such as graphics and other visualization-related processing.

A chipset 706 may provide an interface between the CPU(s) 704 and the remainder of the components and devices on the baseboard. The chipset 706 may provide an interface to a random access memory (RAM) 708 used as the main memory in the computing device 700. The chipset 706 may further provide an interface to a computer-readable storage medium, such as a read-only memory (ROM) 720 or non-volatile RAM (NVRAM) (not shown), for storing basic routines that may help to start up the computing device 700 and to transfer information between the various components and devices. ROM 720 or NVRAM may also store other software components necessary for the operation of the computing device 700 in accordance with the aspects described herein.

The computing device 700 may operate in a networked environment using logical connections to remote computing nodes and computer systems through local area network (LAN) 716. The chipset 706 may include functionality for providing network connectivity through a network interface controller (NIC) 722, such as a gigabit Ethernet adapter. A NIC 722 may be capable of connecting the computing device 700 to other computing nodes over a network 716. It should be appreciated that multiple NICs 722 may be present in the computing device 700, connecting the computing device to other types of networks and remote computer systems.

The computing device 700 may be connected to a mass storage device 728 that provides non-volatile storage for the computer. The mass storage device 728 may store system programs, application programs, other program modules, and data, which have been described in greater detail herein. The mass storage device 728 may be connected to the computing device 700 through a storage controller 724 connected to the chipset 706. The mass storage device 728 may consist of one or more physical storage units. A storage controller 724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 700 may store data on a mass storage device 728 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 728 is characterized as primary or secondary storage and the like.

For example, the computing device 700 may store information to the mass storage device 728 by issuing instructions through a storage controller 724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 may further read information from the mass storage device 728 by detecting the physical states or characteristics of one or more particular locations within the physical storage units.

In addition to the mass storage device 728 described above, the computing device 700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 700.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 728 depicted in FIG. 7, may store an operating system utilized to control the operation of the computing device 700. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 728 may store other system or application programs and data utilized by the computing device 700.

The mass storage device 728 or other computer-readable storage media may also be encoded with computer-executable instructions, which, when loaded into the computing device 700, transforms the computing device from a general-purpose computing system into a special-purpose computer capable of implementing the aspects described herein. These computer-executable instructions transform the computing device 700 by specifying how the CPU(s) 704 transition between states, as described above. The computing device 700 may have access to computer-readable storage media storing computer-executable instructions, which, when executed by the computing device 700, may perform the methods described in relation to FIG. 4, FIG. 5, FIG. 6, and elsewhere herein.

A computing device, such as the computing device 700 depicted in FIG. 7, may also include an input/output controller 732 for receiving and processing input from a number of input devices, such as a keyboard, a mouse, a touchpad, a touch screen, an electronic stylus, or other type of input device. Similarly, an input/output controller 732 may provide output to a display, such as a computer monitor, a flat-panel display, a digital projector, a printer, a plotter, or other type of output device. It will be appreciated that the computing device 700 may not include all of the components shown in FIG. 7, may include other components that are not explicitly shown in FIG. 7, or may utilize an architecture completely different than that shown in FIG. 7.

As described herein, a computing device may be a physical computing device, such as the computing device 700 of FIG. 7. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, by a user device and from a wireless network, a message indicating that the user device can connect to the wireless network to download an embedded subscriber identity module (eSIM) associated with the wireless network;
based on receiving the message, causing a first connection to be established between the user device and the wireless network;
based on downloading the eSIM via the first connection, causing a second connection to be established between the user device and the wireless network; and
based on the second connection, accessing at least one service provided by the wireless network.

2. The method of claim 1, wherein the user device is unable to access, via the first connection, the at least one service provided by the wireless network.

3. The method of claim 1, wherein causing the first connection to be established between the user device and the wireless network comprises sending, to the wireless network, an indication of a request to download the eSIM.

4. The method of claim 1, wherein receiving the message indicating that the user device can connect to the wireless network to download the eSIM is based on scanning, by the user device, for available wireless networks.

5. The method of claim 1, wherein the message comprises a system information block (SIB) message.

6. The method of claim 1, wherein the first connection comprises a limited connection, and wherein downloading the eSIM comprises downloading the eSIM from at least one server associated with the wireless network via the limited connection.

7. The method of claim 1, wherein the user device is associated with a device identifier, the method further comprising:
based on the device identifier corresponding to the eSIM, receiving an indication of a location associated with the eSIM, wherein downloading the eSIM comprises downloading the eSIM from at least one server associated with the wireless network based on the indication of the location associated with the eSIM.

8. The method of claim 1, wherein the user device is associated with a device identifier, the method further comprising:
based on the device identifier not corresponding to the eSIM, receiving an indication to select a subscription associated with the wireless network; and
based on a selected subscription associated with the wireless network, receiving an indication of a location associated with the eSIM, wherein downloading the eSIM comprises downloading the eSIM from at least one server associated with the wireless network based on the indication of the location associated with the eSIM.

9. The method of claim 1, wherein the at least one service comprises at least one of a voice communication service, a messaging communication service, or a mobile data service.

10. A method comprising:
sending, by a wireless network and to a user device, a message indicating an option to establish a first connection with the wireless network to download an embedded subscriber identity module (eSIM) associated with the wireless network;
based on the message, receiving a request, from the user device, to establish the first connection between the user device and the wireless network;
based on the request, causing the first connection to be established between the user device and the wireless network; and
based on the user device downloading the eSIM via the first connection, providing the user device with access to at least one service via a second connection that is established between the user device and the wireless network.

11. The method of claim 10, further comprising:
based on the first connection, determining limited access rights to at least one service by the user device.

12. The method of claim 10, wherein receiving the request, from the user device, to establish the first connection between the user device and the wireless network comprises receiving an indication of a request to download the eSIM.

13. The method of claim 10, wherein the message comprises a system information block (SIB) message.

14. The method of claim 10, wherein the at least one service comprises at least one of a voice communication service, a messaging communication service, or a mobile data service.

15. A method comprising:
receiving, from a user device and via a first connection between the user device and a wireless network, a device identifier associated with the user device;
determining whether the device identifier corresponds to an embedded subscriber identity module (eSIM) associated with the wireless network; and
based on determining whether the device identifier corresponds to the eSIM, causing a second connection to be established between the user device and the wireless network, wherein the user device is configured to access at least one service provided by the wireless network via the second connection.

16. The method of claim 15, wherein the device identifier comprises an embedded universal integrated circuit card identifier.

17. The method of claim 15, wherein the user device is not provided access to the at least one service provided by the wireless network based on the first connection.

18. The method of claim 15, wherein causing the second connection to be established between the user device and the wireless network comprises sending, to the user device, an indication of a location associated with the eSIM, and wherein the user device is configured to download the eSIM from at least one server associated with the wireless network based on the indication of the location associated with the eSIM.

19. The method of claim 15, wherein determining if the device identifier corresponds to the eSIM comprises determining that the device identifier corresponds to the eSIM, wherein causing the second connection to be established between the user device and the wireless network comprises sending, to the user device, an indication of a location associated with the eSIM, and wherein the user device is configured to download the eSIM from at least one server associated with the wireless network based on the indication of the location associated with the eSIM.

20. The method of claim 15, wherein determining if the device identifier corresponds to the eSIM comprises determining that the device identifier does not correspond to the eSIM, wherein causing the second connection to be established between the user device and the wireless network comprises:
sending, to the user device, an indication to select a subscription associated with the wireless network, and
based on a selected subscription associated with the wireless network, sending, to the user device, an indication of a location associated with the eSIM, and
wherein the user device is configured to download the eSIM from at least one server associated with the wireless network based on the indication of the location associated with the eSIM.
